(19) United States
(12) Patent Application Publication
(10) Pub. No.: US 2026/0264660 A1
(43) Pub. Date: Sep. 10, 2026

(54) METHOD FOR CONTROLLING AN ELECTROMECHANICAL BRAKE OF A VEHICLE AND DEVICE FOR CARRYING OUT THE METHOD

(71) Applicant: ZF CV Systems Global GmbH, Bern (CH)

(72) Inventors: Felix Müller-Deile, Hannover (DE); Jan Reiners, Hannover (DE); Christoph Moritz, Hannover (DE)

(21) Appl. No.: 19/556,393

(22) Filed: Mar. 4, 2026

(30) Foreign Application Priority Data
Mar. 5, 2025 (EP) 25161852.6

(51) Int. Cl. B60T 17/22; B60T 13/74

(52) U.S. Cl. CPC B60T 17/221; B60T 13/746; B60T 2250/04

(57) ABSTRACT

A method (100) for controlling an electromechanical brake (12) of a vehicle (10) includes determining a target rotational position (34) for a motor (16) of the electromechanical brake (12) using a brake control unit (30), setting a rotational position (62) of the motor (16) to the target rotational position (34) using a motor control unit of the electromechanical brake (12). The method includes detecting that the target rotational position (34) is constant, and, after setting the rotational position (62), changing the rotational position (62) to a position differing from the target rotational position (34) while the determined target rotational position (34) is constant. A system having the brake control unit and the motor control unit carries out the method. A vehicle includes the system and carries out the method.

### FIELD

The present disclosure relates to the field of brake devices for vehicles, in particular passenger cars and utility vehicles, such as trucks, semitrailers or agricultural tractors.

### BACKGROUND

Brake systems of vehicles, such as utility vehicles or passenger cars, are well known from the prior art. Brake systems of a vehicle usually include one brake piston per wheel of the vehicle, the brake piston, when actuated, for example by a brake pedal, pressing one or more brake pads connected to a brake piston against a brake disk of the respective wheel in order to create a braking effect.

Up until now, a brake piston of a brake system has been operated with a fluid in the majority of vehicles, a pressure in a pressure chamber being increased or reduced by the fluid in order to thereby move the brake piston against a spring in the pressure chamber depending on the pressure. Brake cylinders are often operated by compressed air, particularly in utility vehicles.

However, fluid-operated brake systems are increasingly being replaced by purely electric brake systems that do not require a fluid.

Electric brake systems include several electromechanically applied brakes, each of which is associated with a wheel and has a motor. Depending on a rotational position of the motor, a brake piston is moved, like that in fluid-operated brake systems, by way of converting the rotational movement of the motor into a longitudinal movement of the piston in order to press brake pads against the associated brake disk and thus create a braking effect.

In the case of a service brake which is implemented with electromechanical brakes, a force dependent on a position of the brake pedal is applied to the brake disk by the brake pad by way of an electric motor of the respective electromechanical brake adopting a rotational position dependent on the position of the brake pedal. The motor maintains the position until a brake control unit ascertains a braking force changed depending on the position of the brake pedal or varies the brake pedal position. Particularly when driving downhill at a constant speed or when stopping at traffic lights, the brake control unit can thus specify certain rotational positions of the motor which are adopted for a relatively long period of time since a braking force to be used for such situations remains constant over this period of time. The motor may adopt an unfavorable electrical state in its rotational position specified by the specified braking force. Particularly if the motor is a three-phase motor, a rotational position in which, for example, a particularly high current flows in one of the three phases and a comparatively low current flows in the other two phases can also be requested, so that an asymmetrical load occurs. Damage to the motor can result if this particularly high current flows in one of the phases for a relatively long period of time. In addition to the motor itself, the power electronics that actuate the motor, specifically an inverter for example, may also be damaged by such a prolonged asymmetrical load.

In order to counter this, it is known to design the windings of the motor with electrical conductors which have an oversized cross section and are accordingly configured to carry a comparatively high current compared to normal operation for a relatively long period of time in certain situations. The electrical components and lines of the power electronics may also be correspondingly oversized. However, this oversizing is not desirable since it increases the overall costs of an electromechanical brake. In particular, such a motor also requires a relatively large amount of installation space, this sometimes not being available or being difficult to provide.

### SUMMARY

The object of the present disclosure is therefore to counter the problems faced in the prior art. In particular, a solution is to be found for an electromechanical brake of a vehicle that prevents damage to a motor or the power electronics of the electromechanical brake at a constant braking force demand, without the motor or the power electronics having to be oversized. In any case, the intention is to find an alternative to what is known from the prior art.

To this end, the present disclosure includes a method for controlling an electromechanical brake of a vehicle as described according to various aspects herein.

Accordingly, the present disclosure relates to a method for controlling an electromechanical brake of a vehicle, which method is preferably carried out at least in part using a brake control unit and/or a motor control unit of the electromechanical brake.

First, a target rotational position for a motor of an electromechanical brake is determined using the brake control unit. The target rotational position is preferably generated depending on a braking demand signal, which is received, for example, from an input device, such as a pedal or a lever. A driver of the vehicle can accordingly indicate a service braking request by actuating a brake pedal for example, the driver indicating that they wish to slow down or brake the vehicle by way of the service braking request. The braking demand signal, which indicates the braking request, is supplied to the brake control unit and the brake control unit then determines, depending on further data, such as a current speed and/or a mass of the vehicle for example, which braking forces are to be generated by the individual brake actuators on the individual wheels of the vehicle in order to best meet the requirements of the driver.

A target rotational position at which the brake control unit preferably expects the determined braking force is then determined for at least one of the motors of the electromechanical brakes. The determined target rotational position is then transmitted to a motor control unit of the electromechanical brake and a rotational position of the motor which corresponds to the target rotational position or is dependent on the target rotational position is set using the motor control unit.

Accordingly, the target rotational position is preferably determined using the brake control unit and the determined target rotational position is transmitted to a motor control unit of the electromechanical brake. The motor control unit is preferably configured to actuate the electric motor. The motor control unit is preferably a converter controller of the electromechanical brake, which can also be simply referred to as a converter, and generates multiphase currents as the control signal in order to set rotational positions of the motor. Accordingly, the motor control unit preferably generates the control signal, which can also be referred to as the target rotational position signal, depending on the target rotational position in order to control the motor. This control signal is preferably a multiphase signal in order to drive the phases of the motor.

Once the rotational position of the motor has been set or even as early as during setting of the rotational position, the brake control unit preferably continuously monitors the behavior of the vehicle and redetermines the target rotational position if the braking force expected by the brake control unit does not correspond to the real behavior of the vehicle. If the target rotational position is not changed because, for example, the behavior of the vehicle at the set rotational position corresponds to the behavior expected by the braking demand signal and the behavior expected by the brake control unit, the target rotational position is kept constant and in particular this situation of keeping the target rotational position constant is detected by the motor control unit. The target rotational position is preferably detected as constant as soon as the target rotational position remains unchanged for more than a specified period of time, that is to say a time period. The period of time is preferably predefined, for example by tests, and preferably stored in the motor control unit. The period of time approximately corresponds to a period in the range of from ten seconds to one minute. However, the period of time can also correspond to a period of less than one second. However, the target rotational position is particularly preferably only detected as constant if the target rotational position differs from a rest position. For example, a rest position is predefined and corresponds to a position at which no braking force is generated.

According to the present disclosure, in the case that the determined target rotational position remains constant, that is to say is identified as constant, the rotational position of the motor is changed after a rotational position has been set depending on the target rotational position. A determined target rotational position is considered constant if it remains unchanged at least for a predefined period of time, that is to say for longer than this period of time. This means that a determined target rotational position is constant as long as the brake control unit does not determine a new target rotational position, which differs from the previously determined target rotational position, within the period of time. While the target rotational position is constant thus preferably denotes a period which begins as soon as the target rotational position is detected as constant and ends when a new target rotational position is determined.

Furthermore, the motor control unit preferably determines that the target rotational position is constant. As soon as the target rotational position is determined as a constant target rotational position, the motor control unit preferably changes the rotational position of the motor to a position differing from the target rotational position. The control signal is accordingly adapted by the motor control unit to this end.

The present disclosure is thus based on the knowledge that, in electromechanical brakes with multiphase motors, such as a three-phase AC motor, asymmetrical energization can occur when the motor is at a standstill, depending on the position of the motor, this resulting in high current heat losses, and such states of asymmetrical energization should be avoided. The present disclosure is also based on the knowledge that a linear movement for moving the brake pads, for example by way of a piston or tappet which is moved by the motor owing to rotational movement of the motor, is performed by a transmission ratio which is selected to be very large. Accordingly, a large number of motor revolutions are necessary in order to enable a comparatively short linear movement of the brake pads. The linear movement of the brake pads corresponds to a movement for applying or releasing the brake and can also be referred to as travel. Due to the transmission ratio, 30 to 60 full revolutions of the motor, for example, are accordingly required for the distance from a state in which the brake pads are at a maximum distance from a brake disk to the state in which a braking effect occurs. This transmission ratio is used to keep the torque demands on the motor low. It has thus been identified that a target rotational position specified by the motor in order to obtain a desired braking effect can be adopted with a wide tolerance range, which includes an entire motor speed range for example. There is substantially no change in the braking force within this tolerance range since motor rotation within the tolerance range results in a linear movement which is comparatively low. Owing to this wide tolerance range, the motor can accordingly be moved to an alternative rotational position instead of the target rotational position, the mentioned unfavorable high currents in an individual phase not occurring in the alternative rotational position.

In particular, in the method, the target rotational position is continuously determined using the brake control unit, for example with a frequency with which a pedal position is detected or sampled for example, or the target rotational position is determined in an event-dependent manner if a pedal position changes, for example. In addition, the target rotational position can also be determined, for example depending on a current acceleration, a speed or an activated ABS function.

The target rotational position is specified in degrees, for example. Accordingly, a target rotational position at which the motor keeps the brake pads furthest away from a brake disk could be referred to as the zero position. If, for example, it is accordingly provided that the motor has to carry out 50 revolutions until a tappet or piston is at its fully extended position relative to the zero position, such a position corresponds to a rotational position of 18,000 degrees, that is the product of 50 revolutions and 360 degrees. A target rotational position, which is intended to be adopted by the motor at 720 degrees for example, corresponds to two full revolutions from the zero position or zero-degree position.

Changing of the rotational position from a rotational position specified by the target rotational position when the target rotational position is specified to be constant is advantageous in order to avoid an unfavorable state of the motor. An oversized design of the motor and the associated power electronics is therefore not necessary in order to permanently supply the mentioned high currents in unfavorable states of the motor.

According to a first embodiment, the method further includes checking a criterion. The step of changing the rotational position to a position differing from the target rotational position is carried out or not carried out depending on whether the criterion is met or whether the criterion is not met. In particular, if the criterion is met, the rotational position is changed while the target rotational position is constant. If the criterion is not met, the rotational position remains constant as long as the target rotational position is constant. Accordingly, it is preferably first detected that the target rotational position is constant, and a check as to whether the criterion is met is made at the same time or only thereafter.

Therefore, it is possible to determine, for example, whether the motor is actually in an unfavorable rotational position in the rotational position set by the specified target rotational position depending on sensor values of the motor which are present in the motor controller, for example. For example, a temperature of the motor can be monitored and a criterion can be established requiring that the temperature has to lie above a threshold value in order to meet the criterion. This means that a motor that is very hot due to a high current can be identified and the rotational position changed only in such a case. By not changing the rotational position in certain situations, but rather holding it in the rotational position specified by the target rotational position, it is possible to ensure that precisely the desired braking force that is demanded by the brake control unit with the target rotational position is maintained. Despite the high transmission ratio mentioned above, it is possible to ensure that a rotational position is not unnecessarily changed in situations in which protection of the motor is not necessary.

According to a further embodiment, changing the rotational position while the target rotational position is constant includes continuously changing the rotational position.

This means that as soon as it is changed from the target rotational position to another position, the rotational position is continuously further changed, that is at short intervals or with a specified frequency, for example. Continuous changing of the rotational position is therefore preferably performed as long as the target rotational position is detected as constant.

By continuously changing the rotational position of the motor, it is possible for it to not be necessary to precisely determine whether a rotational position of the motor is an electrically more suitable or unsuitable position. Rather, continuously changing the rotational position renders it possible for particularly unfavorable positions to be adopted at least only briefly.

According to a further embodiment, changing the rotational position while the target rotational position is constant includes changing the rotational position in a range. The range is delimited by a minimum rotational position and a maximum rotational position. The range accordingly includes all possible rotational positions between a minimum rotational position and a maximum rotational position. The target rotational position lies in this range. The target rotational position preferably lies in the middle or substantially in the middle of this range. This range particularly preferably also includes the minimum rotational position and the maximum rotational position. Accordingly, a minimum rotational position and a maximum rotational position are specified, these rotational positions forming a region in which the target rotational position itself lies. For example, the minimum rotational position and the maximum rotational position can both be specified as an absolute value or as a relative value of an angle in degrees starting from the target rotational position. If, for example, the target rotational position corresponds to an angle of 5000 degrees, the minimum rotational position corresponds, for example, to 4910 degrees and the maximum rotational position corresponds to 5090 degrees. The range then includes half a revolution of the motor.

Changing the rotational position of the motor in a range delimited by or including the minimum rotational position and the maximum rotational position thus renders it possible for there to be no excessive change or arbitrary change in the rotational position and thus for no rotational position which results in an undesirable braking force to be adopted by the motor when the rotational position of the motor is changed, as long as the target rotational position is constant.

According to a further embodiment, changing of the rotational position while the target rotational position is constant is performed with an angle value of the rotational position which moves back and forth in a waveform between the minimum rotational position and the maximum rotational position as a function of time. Preferably, the target rotational position corresponds to a mean maximum amplitude of the waveform, the maximum rotational position corresponds to the maximum amplitude and the minimum rotational position corresponds to the minimum amplitude of the waveform. The waveform thus corresponds to a time profile between a minimum and a maximum amplitude. The waveform is preferably a sinusoidal form. The waveform additionally has a frequency which lies below 10 Hz, preferably below 5 Hz or particularly preferably below 2 Hz. The frequency of the waveform is preferably higher than 1 Hz.

According to a further embodiment, the minimum rotational position corresponds to a rotational angle value which is smaller than a rotational angle value of the target rotational position by a rotational angle amount. The maximum rotational position corresponds to a rotational angle value which is greater than a rotational angle value of the target rotational position by a rotational angle value amount. This means that a rotational angle amount is defined and the minimum rotational position is smaller than the target rotational position by the rotational angle value amount and the maximum rotational position is greater than the target rotational position by the rotational angle value amount. The rotational angle value amount preferably corresponds to a full revolution of the rotor of the motor, that is to say 360 degrees, divided by the number of pole pairs. According to one alternative, the rotational angle value amount is the full revolution of the rotor of the motor divided by double the number of pole pairs.

This embodiment takes into account that, in the case of a non-optimal position of the motor, a portion of a full rotor revolution is already sufficient to move the motor to a more suitable position, this portion being dependent on the number of pole pairs. According to the embodiment, it is accordingly provided that the rotational position of the motor is rotated forward and backward by an entire electrical revolution in the case of a full rotor revolution divided by the number of pole pairs, or rotated forward and backward by half an electrical revolution in the case of a rotor revolution divided by double the number of pole pairs.

Within these limits, in particular if the rotational position moves in a wave shape or sinusoidally between the minimum rotational position defined in this way and the maximum rotational position, it can be assumed that unfavorable positions of the motor are adopted sufficiently rarely that a special design of the motor is not necessary to maintain a braking force during a constant unfavorable target rotational position.

According to a further embodiment, the criterion is either met or not met. In order for the criterion to be met, one or more conditions have to occur, where the occurrence of a met condition, in particular during or at the time of checking the criterion, may have already passed or be in the process of being performed. If one or more of the following conditions have accordingly occurred, the criterion is met; if none of the following conditions have occurred, the criterion is not met.

According to a first condition, a current speed of the vehicle is below a predefined speed threshold value. The speed threshold value is preferably 5 km/h or 1 km/h or 0.25 km/h. The speed threshold value is preferably less than 5 km/h, less than 1 km/h or less than 0.25 km/h. A further condition which, if it is additionally or alternatively met, meets the criterion is that a current flows in at least one phase of the motor, the magnitude of the current lying above a current threshold value. The magnitude preferably lies above the current threshold value for a predefined period of time, that is to say at least for a predefined period. The predefined period corresponds, for example, to the time period starting from which a target rotational position is detected as constant. A further condition is that a torque of the motor lies above a torque threshold value. The torque of the motor preferably also has to lie above the torque threshold value at least for a further or the predefined period in order for the condition to have occurred and the criterion to be met. A further condition is that one or more state parameters indicate a predefined state of the electromechanical brake. Such states can indicate, for example, whether the electromechanical brake has overheated and/or a retarder function is activated. Accordingly, the condition is also met, for example, when the state parameter indicates that a retarder function is activated. If, in contrast, the retarder function is not activated, the condition has not occurred and the criterion is not met, unless another condition has occurred. Even though several possible conditions are mentioned according to this embodiment, various embodiments of the present disclosure in which only one or several of the conditions mentioned are also checked are included.

According to one exemplary embodiment, only the condition as to whether the current speed of the vehicle lies below a predefined speed threshold value is accordingly checked and the criterion is only considered to be met if this condition has occurred. Otherwise, the criterion is not met, even if one of the other conditions mentioned above were theoretically met.

Accordingly, the method includes identifying a target rotational position as a constant target rotational position, for example by way of the target rotational position having remained constant for a predefined period of time. The rotational position of the motor preferably remains in a position corresponding to the target rotational position as long as the target rotational position has not yet been identified as constant. As soon as the target rotational position is identified as a constant target rotational position, a check is made in the next step as to whether the criterion is met. The conditions are checked for this purpose. If the conditions are, in turn, dependent on their own periods of time or durations, a check is made, for example in the case of a current to be checked through one phase of the motor, as to whether this current has already been above a current threshold value for a predefined period of time. If this is not the case, the rotational position of the motor is still kept at the target rotational position. If, on the other hand, the target rotational position remains constant and the period of time for monitoring the current also elapses, that is to say if the current then lies above the current threshold value for the predefined period of time, changing of the rotational position at a constant target rotational position is activated.

Accordingly, the state of the electromechanical brake is checked and changing of the rotational position is carried out only when this is really necessary in order to protect the motor. In particular, the condition concerning the current speed of the vehicle additionally takes into account that a change in the rotational position is carried out only when the vehicle is substantially stationary anyway and therefore an influence on the braking force due to changing the rotational position has no significant effects on the behavior of the vehicle.

According to a further embodiment, the target rotational position is continuously ascertained using a brake control unit and the motor of the electromechanical brake is actuated with a control signal. The control signal can either be generated directly by the brake control unit or corresponds to a signal which is generated by a motor control unit of the electromechanical brake depending on the target rotational position. The motor control unit preferably corresponds to a converter controller.

Furthermore, the brake control unit or preferably the motor control unit includes a normal mode. The normal mode is adopted as long as the ascertained target rotational position is not detected as constant. As soon as the ascertained target rotational position is detected as constant and preferably the criterion is met, the motor control unit or the brake control unit switches from its normal mode to a protection mode.

In the normal mode, the control signal corresponds to a target rotational position signal with which the rotational position is set to the or depending on the target rotational position. In the protection mode, a superimposition signal is superimposed on the target rotational position signal, in particular by the motor control unit. The resulting superimposed signal consisting of the target rotational position signal and the superimposition signal then corresponds to the control signal for actuating the motor in the protection mode. In the protection mode, changing of the rotational position to a position differing from the target rotational position is performed by the superimposed signal.

The superimposition signal preferably corresponds to a continuous variation of a waveform here. Accordingly, the superimposition signal preferably corresponds to rotational positions which change over time such that, when time is plotted on an X axis of a time function and speed is specified on a Y axis that is perpendicular to the X axis, the signal shape corresponds to a continuous variation of a waveform. In particular, the signal shape corresponds to a sinusoidal form, a triangular form or a rectangular form. The superimposition signal preferably has a frequency which is less than 5 Hz or less than 2.5 Hz or less than 1 Hz. The superimposition signal or the superimposed signal preferably varies with the waveform between the minimum rotational position and the maximum rotational position. The waveform accordingly has a minimum and a maximum amplitude, where the minimum amplitude corresponds to the minimum rotational position and the maximum amplitude corresponds to the maximum rotational position. Conversely, the minimum amplitude can also correspond to the maximum rotational position and the maximum amplitude can correspond to the minimum rotational position.

According to one embodiment, the motor control unit is designed as a converter which, in the normal mode, outputs the target rotational position signal to actuate the motor, that is to say to maintain a rotational position. In the protection mode, the superimposition signal, which is generated in the converter, is superimposed on the target rotational position signal, so that the resulting control signal follows a shape of the superimposition signal, which is preferably shifted by the target rotational position signal.

Due to superimposition of a target rotational position signal, in particular if it is in the form of an analog signal, the electric motor can be easily actuated by varying the rotational position.

According to a further embodiment, in the case that several electromechanical brakes of the vehicle, in particular on the same axle of the vehicle, are actuated in such a way that their rotational positions are changed while the respective target rotational position is detected as constant, a uniform superimposition signal is output to these several electromechanical brakes and preferably superimposed on the respective target rotational position signal. Accordingly, the superimposition signals on the different electric motors preferably have an identical phase and/or an identical amplitude.

Uniform superimposition signals allow a braking force on all of the wheels of a vehicle, in particular on one axle, to be uniformly changed. This renders it possible for the resulting change in braking force to have as little a negative effect on the driving behavior as possible. In particular, this can be used to counteract uneven braking between the sides, which could lead to pulling, for example.

According to a further embodiment, in the case that a fault detected using the brake control unit occurs on one or more electromechanical brakes, the superimposition signal is generated in a special manner. Accordingly, if changing of the rotational position to a position differing from the target rotational position while the determined target rotational position is detected as constant is carried out for several electromechanical brakes, in particular on the same axle of a vehicle, and a fault is identified at the same time, superimposition signals which are non-uniform are generated for the respective electromechanical brakes. Non-uniform means that the superimposition signals in particular have a non-identical phase and/or a non-identical amplitude.

In the case of a fault, a driver can thus be made aware of the fault by noticeable uneven braking. A fault in one or more electromechanical brakes can thus be identified by the driver more quickly.

The present disclosure further includes a system including a brake control unit, which system is configured to carry out the method according to any of the embodiments.

The system is configured to carry out the method according to any of the embodiments. In particular, the system includes a brake control unit which is configured to determine a target rotational position for a motor of an electromechanical brake and to transmit the determined target rotational position to the electromechanical brake, in particular a motor control unit of the motor. The motor is configured to set a rotational position of the motor to the target rotational position or a position dependent on the target rotational position. To this end, the motor is preferably controlled with a control signal using the motor control unit, the control signal being dependent on the ascertained target rotational position.

In addition, the system is configured to change the rotational position to a position differing from the target rotational position while the determined target rotational position is identified as constant, preferably after the rotational position has been set to the target rotational position or a rotational position dependent on the target rotational position.

According to one embodiment of the system, this system is configured to generate a control signal for actuating the motor. Here, the control signal is either generated directly by the brake control unit or the control signal is generated by a motor control unit depending on the target rotational position detected. The motor control unit is preferably a converter controller of the electromechanical brake for the electric motor of the system. In the case that the control signal is generated by the motor control unit, the motor control unit receives the target rotational position from the brake control unit. Furthermore, the brake control unit, when it generates the control signal, has either a normal mode or a protection mode. If the motor control unit generates the control signal, the motor control unit has a normal mode or a protection mode. In the normal mode, the control signal is set to the target rotational position with the control signal. The control signal is also referred to as the target rotational position signal in the normal mode. In the protection mode, a superimposition signal is superimposed on the target rotational position signal. The signal superimposed in this way now forms the control signal.

The superimposition signal is preferably a wave-shaped signal which particularly preferably runs between a minimum amplitude, which preferably corresponds to a minimum rotational position, and a maximum amplitude, which preferably corresponds to a maximum rotational position, in particular when the superimposition signal is superimposed on the target rotational position signal. The superimposition signal preferably has a frequency which is less than 5 Hz or less than 2.5 Hz or less than 1 Hz. The superimposition signal preferably has a sinusoidal form, a triangular form or rectangular form.

According to one embodiment, the system includes an input device, such as a pedal. According to one alternative, the input device can also be a manual lever or a virtual driver, specifically an autonomous controller of the vehicle. The input device is configured to generate a braking demand signal depending on detected actuation or, in the case of a virtual driver, depending on a specification by the virtual driver. The brake control unit is then configured to generate a target rotational position depending on the braking demand signal.

The present disclosure also relates to an electromechanical brake including an electric motor and a motor control unit for actuating the motor. The motor control unit is configured to set a rotational position of the motor depending on a determined target rotational position. The target rotational position is preferably determined by a brake control unit and thus specified for the motor control unit. The motor control unit includes a normal mode and a protection mode. In the normal mode, the rotational position of the motor is set to the target rotational position with a control signal, which corresponds to a target rotational position signal. As soon as the target rotational position is set, the target rotational position signal becomes constant, in order to maintain the rotational position. In the protection mode, a superimposition signal is superimposed on the control signal, which corresponds to the target rotational position signal, in order to thus generate a superimposed target rotational position signal. The superimposed target rotational position signal is then used to change the rotational position. The protection mode is preferably set by the motor control unit when the specified target rotational position is constant or is detected as constant. A constant target rotational position is preferably identified by the motor control unit when the determined target rotational position is constant for a specified period of time, that is to say no new determined target rotational position is received by the brake control unit within the period of time.

According to a further embodiment, the motor control unit is configured to distinguish a determined target rotational position from a constant determined target rotational position. According to a further embodiment, the motor control unit is configured to check whether a criterion is met or not. The criterion is preferably met when one of the conditions mentioned above is met. The motor control unit is further configured to switch to the protection mode only if the criterion is also met. This means that even if the determined target rotational position is constant and the criterion is not met, the motor control unit remains in the normal mode and does not switch to the protection mode.

The present disclosure also relates to a vehicle. The vehicle is configured to carry out the method according to any of the embodiments mentioned above. The vehicle preferably includes a system according to any of the embodiments mentioned or an electromechanical brake according to any of the embodiments mentioned.

### BRIEF DESCRIPTION OF THE DRAWINGS

Further embodiments will emerge from the exemplary embodiments discussed in more detail in the figures. In the figures:

FIG. 1 shows a system according to one exemplary embodiment;

FIG. 2 shows a control signal according to one exemplary embodiment, and

FIG. 3 shows the steps of the method according to one exemplary embodiment.

### DETAILED DESCRIPTION

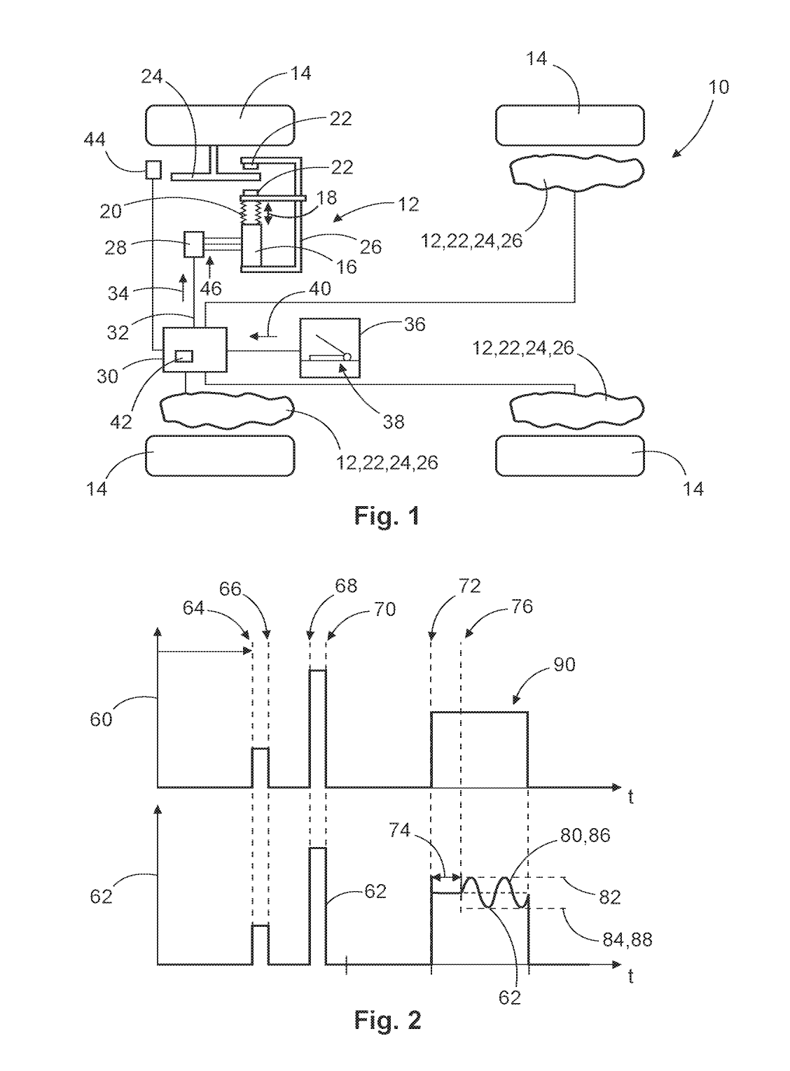

FIG. 1 shows a vehicle 10 according to one exemplary embodiment of the present disclosure. The vehicle 10 includes an electromechanical brake 12, which is shown by way of example only for one of the four wheels 14 shown, each of the wheels 14 having an electromechanical brake 12. The electromechanical brake 12, which is shown in detail, includes an electric motor 16 which has a rotor and a stator in the interior. The rotor is preferably designed with an internal thread in order to move a piston 20, which can be displaced in a longitudinal direction 18 with an external thread, depending on its rotational position. According to a particularly preferred refinement, the rotation of the motor is converted into a translation by means of a mechanical transmission. The movement of the piston 20 is transmitted to brake pads 22 in order to thus press them against a brake disk 24 and generate a braking force. The brake disk 24, the brake pads 22 and a brake caliper 26 for guiding the brake pads 22 are also provided on all of the wheels 14, but are not shown in detail.

The electromechanical brake 12 includes, in addition to the motor 16, a motor control unit 28 which is connected to a brake control unit 30 via a data line 32 in order to receive target rotational positions 34 via the data line 32. The target rotational positions 34 are transmitted individually or together from the brake control unit 30 to all of the electromechanical brakes 12. The target rotational positions 34 are generated depending on an actuation of an input device 36, which corresponds to a pedal 38 here. The pedal 38 is a brake pedal. A braking demand signal 40 is transmitted to the brake control unit 30 depending on a position of the brake pedal. The brake control unit 30 further includes an acceleration sensor 42 and is connected to wheel speed sensors 44 of at least one of the wheels 14 in order to determine a current speed of the vehicle 10. The target rotational position 34 is transmitted to the motor control unit 28 depending on the braking demand signal 40 and a determined speed and/or acceleration. Depending on the target rotational position 34 determined by the brake control unit 30, a control signal 46 is then generated using the motor control unit 28 in order to control the motor 16.

FIG. 2 shows two time profiles, the time profile of the target rotational position 34 being plotted over the vertical axis 60 and the horizontal axis corresponding to the time axis in the upper part of FIG. 2. In the lower part of FIG. 2, the time axis also runs in the horizontal direction with the same time division as on the upper time axis, with a rotational position 62 of the motor 16, which is set depending on the control signal 46, being plotted on the vertical axis 60.

In the time profile, which begins at the point of intersection of the axes, a target rotational position 34, which corresponds to a rest position of the electromechanical brake 12, is specified up to time 64. This rest position can represent a zero position or zero rotational position of the motor, but is not limited to the piston 20 being fully retracted into the motor 16 or extended in this case. Rather, this rest position is to be described as a position in which no braking force is generated by the electromechanical brake 12. The rest position corresponds, for example, to a target rotational position 34 which provides sufficient clearance taking into account the current wear of brake pads 22 and the brake disk 24. This rest position is preferably accordingly also dependent on the wear of the electromechanical brake 12.

After time 64, the target rotational position 34 is increased and starting from time 66 is moved back to the rest position. At time 64, the new target rotational position 34 is accordingly transmitted to the electromechanical brake 12 and the rotational position 62 changes to the target rotational position 34. At time 66, the new target rotational position 34, which corresponds to a rest position, is, in turn, set as the rotational position 62 by the motor 16. This means that braking is performed between times 64 and 66.

At time 68, a new target rotational position 34 is then specified again and the rotational position 62 of the motor is accordingly set to the new target rotational position 34. At time 70, a target rotational position 34, which corresponds to the rest position, is determined again and accordingly the rotational position 62 of the motor is also adjusted. Second, more pronounced braking is carried out.

At time 72, a new target rotational position 34 is then specified again in order to carry out third braking. The target rotational position 34 is also set as the rotational position 62 using the motor 16. After a predefined period of time 74 has elapsed, the motor control unit 28 of the electromechanical brake 12 identifies that the target rotational position 34 has not changed in this period of time 74, then detects or considers this as constant and switches from a normal mode to a protection mode. A superimposition signal is superimposed on a target rotational position signal starting from time 76, so that the resulting control signal corresponds to a superimposed signal 80, which moves sinusoidally between a maximum amplitude 82 and a minimum amplitude 84. In accordance with this control signal 80, the rotational position 62 also changes between a maximum rotational position 86 and a minimum rotational position 88. At time 90, a new target rotational position 34 is determined, which again corresponds to the rest position, so that the rotational position 62 is also again adapted to the target rotational position 34. The target rotational position is no longer detected as constant and the motor control unit is switched back to the normal mode.

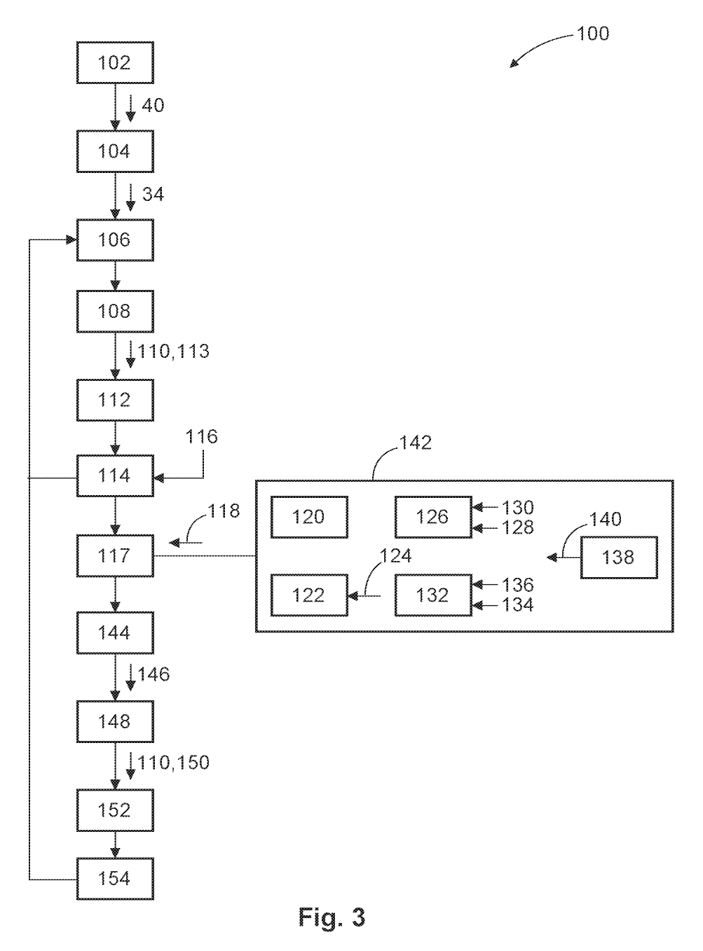

FIG. 3 shows the steps of the method 100 according to one exemplary embodiment. In step 102, a braking demand signal 40 is transmitted to a brake control unit 30 by an input device 36. In step 104, a target rotational position 34 is ascertained depending on the braking demand signal 40, and passed to a motor control unit 28 in step 106. In step 108, a control signal 110 is generated, and a motor 16 of an electromechanical brake 12 is actuated with the control signal 110, which corresponds to a target rotational position signal 113, in step 112. In step 114, the motor control unit 28 checks whether there is already a new determined target rotational position 34 and, in the case that the determined target rotational position 34 has changed, step 106 is carried out again. As long as the target rotational position 34 does not change, a period of time 116 is monitored at the same time. If this period of time 116 elapses and the determined target rotational position 34 still has not changed, a check is made in step 117 as to whether a criterion 118 is met. The criterion 118 is met if the target rotational position 34 differs from a rest position 120, which is predefined for example. The criterion 118 is also met if a current speed 122 lies above a speed threshold value 124, if a current 126, which lies above a current threshold value 128, specifically for at least a predefined period of time 130 which differs from or corresponds to the period of time 116, flows through at least one phase of the motor, or if a torque 132 lies above a torque threshold value 136 for a further period of time 134 and/or a state parameter 138 indicates a predefined state 140. The conditions 142 are determined, for example, based on sensor values and threshold values stored in a memory.

If one or more of the criteria are met, a superimposition signal 146 is generated in step 144. In step 148, the superimposition signal 146 is superimposed on the target rotational position signal 113 in order to output a control signal 110, which corresponds to a superimposed target rotational position signal or superimposed signal 150. Accordingly, in step 152, the motor 16 is actuated with the superimposed target rotational position signal 150. In step 154, the rotational position 62 of the motor is varied depending on the superimposed target rotational position signal 150. This is performed until a new target rotational position 34 is ascertained. Step 106 is then carried out again.

### REFERENCE SIGNS (PART OF THE DESCRIPTION)

10 Vehicle

12 Electromechanical brake

14 Wheels

16 Electric motor

18 Longitudinal direction

20 Piston

22 Brake pads

24 Brake disk

26 Brake caliper

28 Motor control unit

30 Brake control unit

32 Data line

34 Target rotational positions

36 Input device

38 Pedal

40 Braking demand signal

42 Acceleration sensor

44 Wheel speed sensors

46 Control signal

60 Vertical axis

62 Rotational position

64 Time

66 Time

68 Time

70 Time

72 Time

74 Predefined period of time

76 Time

80 Superimposed signal

82 Maximum amplitude

84 Minimum amplitude

86 Maximum rotational position

88 Minimum rotational position

90 Time

100 Method

102 Transmit braking demand signal

104 Ascertain target rotational position

106 Pass on target rotational position

108 Generate control signal

110 Control signal

112 Actuate motor

113 Target rotational position signal

114 Check target rotational position

116 Period of time

117 Check criterion

118 Criterion

120 Rest position

122 Current speed

124 Speed threshold value

126 Current

128 Current threshold value

130 Predefined period of time

132 Torque

134 Further period of time

136 Torque threshold value

138 State parameter

140 Predefined state

142 Conditions

144 Generate superimposition signal

146 Superimposition signal

148 Superimpose target rotational position signal

150 Superimposed target rotational position signal

152 Actuate motor

154 Vary rotational position of the motor

What is claimed is:

1. A method (100) for controlling an electromechanical brake (12) of a vehicle (10), the method comprising:
determining, with a brake control unit (30), a target rotational position (34) for a motor (16) of the electromechanical brake (12),
setting, using a motor control unit of the electromechanical brake (12), a rotational position (62) of a motor (16) of the electromechanical brake (12) to the target rotational position (34) or a position that depends on the target rotational position (34),
detecting that the target rotational position (34) is constant, and
after setting the rotational position (62), changing the rotational position (62) to a position differing from the target rotational position (34) while the determined target rotational position (34) is constant.

2. The method (100) as claimed in claim 1, wherein the method (100) further comprises checking a criterion (118), wherein
changing of the rotational position (62) while the target rotational position (34) is constant is carried out only when the criterion (118) is met during the check, and otherwise the rotational position (62) is kept constant at the target rotational position (34) while the determined target rotational position (34) is constant.

3. The method (100) as claimed in claim 1, wherein changing of the rotational position (62) while the target rotational position (34) is constant is performed continuously.

4. The method (100) as claimed in claim 1, wherein changing the rotational position (62) while the target rotational position (34) is constant comprises changing the rotational position (62) in a range, wherein the range lies between a minimum rotational position (88) and a maximum rotational position (86) and includes the target rotational position (34).

5. The method (100) as claimed in claim 4, wherein the minimum rotational position (88) corresponds to a rotational angle value that is smaller than a rotational angle value of the target rotational position (34) by a rotational angle value amount, and the maximum rotational position (86) corresponds to a rotational angle value which is greater than a rotational angle value of the target rotational position (34) by a rotational angle value amount, wherein the rotational angle value amount corresponds to a full revolution of the rotor of the motor (16) divided by the number of pole pairs or divided by double the number of pole pairs.

6. The method (100) as claimed in claim 2, wherein the criterion (118) is met only when at least one or more of the following conditions (142) occur or occurred when checking the criterion (118):
a current speed (122) of the vehicle (10) lies below a predefined speed threshold value (124),
a current (126) flowing through at least one phase of the motor (16) lies above a current threshold value (128), at least for a predefined period of time (130),
a torque (132) of the motor (16) lies above a torque threshold value (136), at least for the predetermined period of time or a further predefined period of time (130, 134),
one or more state parameters (138) indicate a predefined state (140) of the electromechanical brake (12).

7. The method (100) as claimed in claim 2, wherein the target rotational position (34) is determined using the brake control unit (30), and the motor (16) of the electromechanical brake (12) is controlled with a control signal (110) generated depending on the determined target rotational position (34), using the motor control unit (28),
wherein the control signal (110), in a normal mode in which the target rotational position is detected as non-constant, outputs a target rotational position signal as the control signal (110), the rotational position (62) of the motor (16) being set or maintained at the target rotational position (34) or the position depending on the target rotational position (34), with the target rotational position signal using the motor control unit of the electromechanical brake (12), and
wherein, while the determined target rotational position (34) is detected as constant and the criterion (118) is met, the brake control unit (30) or the motor control unit (28) switches over from the normal mode to a protection mode, in which a superimposition signal (146) is superimposed on the target rotational position signal in order to form the control signal (110).

8. The method (100) as claimed in claim 1, wherein, in the case that changing of the rotational position (62) to a position differing from the target rotational position (34) while the determined target rotational position (34) is detected as constant is carried out for several electromechanical brakes (12) on the same axle of a vehicle (10), the superimposition signals (146) generated for each brake respectively by the motor control unit (28) or the brake control unit (30) are uniform and in have an identical phase and/or identical amplitude.

9. The method (100) as claimed in claim 1, wherein, in the case that a fault is detected by the brake control unit (30) in one or more electromechanical brakes, and changing of the rotational position (62) to a position differing from the target rotational position (34) while the determined target rotational position (34) is detected as constant is carried out for several electromechanical brakes (12) on the same axle of a vehicle (10), the superimposition signals (146) generated for each brake respectively by the motor control unit (28) or brake control unit (30) are non-uniform and in have a non-identical phase and/or non-identical amplitude.

10. A system for carrying out the method (100) as claimed in claim 1, the system comprising:
the brake control unit (30) and
the motor control unit (28),
wherein the system determines the target rotational position (34) for the electromechanical brake (12) using the brake control unit (30),
wherein the system sets a rotational position (62) of a motor (16) of the electromechanical brake (12) to the target rotational position or the position depending on the target rotational position (34),
wherein, after the system sets the rotational position (62), the system changes the rotational position (62) to the position differing from the target rotational position (34) while the determined target rotational position (34) is constant.

11. The system as claimed in claim 10, wherein the brake control unit (30) or the motor control unit (28) generates a control signal (110), which in a normal mode sets the current ascertained target rotational position (34) with a target rotational position signal, wherein the brake control unit (30) or the motor controller superimposes a superimposition signal (146) on the target rotational position signal in a protection mode and outputs the superimposed signal as the control signal (110).

12. The system as claimed in claim 10, further comprising an input device (36), wherein the input device (36) generates a braking demand signal (40) depending on a detected actuation of input device (36), and the brake control unit (30) generates the target rotational position (34) depending on the braking demand signal (40).

13. An electromechanical brake (12), comprising:
an electric motor (16) and
a motor control unit (28) for actuating the motor (16),
wherein the motor control unit (28) sets a rotational position (62) of the motor (16) depending on a determined target rotational position (34),
wherein the motor control unit (28) has a normal mode, in which the rotational position (62) of the motor (16) is set to the target rotational position (34) with a control signal (110) that corresponds to a target rotational position signal (113), and
wherein the motor control unit (28) has a protection mode, in which a superimposition signal (146) is superimposed on the target rotational position signal (113) in order to change the rotational position (62),
wherein the electromechanical brake (12) switches over to the protection mode when the determined target rotational position (34) is detected as constant.

14. The electromechanical brake (12) as claimed in claim 13, wherein the motor control unit (28) is configured to distinguish a determined target rotational position from a constant determined target rotational position or to check whether a criterion (118) is met or not.

15. The method as claimed in claim 1, wherein the motor control unit is a converter controller of the electromechanical brake (12) for the electric motor (16).

16. The method as claimed in claim 4, wherein the target rotational position is in the middle of the range, wherein the range also includes the minimum rotational position (88) and the maximum rotational position (86).

17. The method as claimed in claim 6, wherein the speed threshold value (124) is less than 5 km/h.

18. The method as claimed in claim 17, wherein the speed threshold value (124) is less than 0.25 km/h.

19. The method as claimed in claim 7, wherein the superimposition signal (146) corresponds to a continuous variation of a waveform, in the form of a sinusoidal form, a triangular form, or a rectangular form,
wherein the superimposition signal (146) has a frequency which is equal to or less than 5 Hz or 10 Hz, and
wherein the waveform runs between a minimum amplitude (84) and a maximum amplitude (82), and the minimum amplitude (84) indicates the minimum rotational position (88) and the maximum amplitude (82) indicates the maximum rotational position (86).

20. A vehicle (10) configured to carry out the method (100) as claimed in claim 1.
